(19) United States
(12) Patent Application Publication
(10) Pub. No.: US 2010/0210778 A1
(43) Pub. Date: Aug. 19, 2010

(54) CARBONATE POLYMER BLENDS WITH REDUCED GLOSS

(76) Inventors: Pascal E.R.E.J. Lakeman, Bergen op Zoom (NL); Franciscus J.T. Krabbenborg, Terneuzen (NL); Thomas D. Traugott, Sanford, MI (US); Ronald Wevers, Terneuzen (NL); Nigel Shields, Terneuzen (NL)

Correspondence Address: The Dow Chemical Company, P.O. BOX 1967, Midland, MI, 48641, US

(21) Appl. No.: 12/679,819

(22) PCT Filed: Aug. 25, 2008
(86) PCT No.: PCT/US08/74147

§ 371 Date: Mar. 24, 2010

(30) Foreign Application Priority Data
Sep. 26, 2007 (US) 60995384
Aug. 11, 2008 (US) 61087761

(51) Int. Cl. C08K 3/34; C08L 23/10; C08L 69/00

(52) U.S. Cl. 524/443; 525/63; 525/67; 524/451; 524/445

(57) ABSTRACT

Disclosed is a carbonate polymer blend composition comprising (a) a carbonate polymer, (b) a propylene polymer, (c) a compatibilizing graft copolymer, (d) a polymer selected from a graft modified propylene polymer and/or an alpha-olefin carboxylic acid copolymer, and/or an olefin block copolymer, optionally (e) a filler, (f) optionally a thermoplastic resin other than (a), (b), (c), or (d) and (g) optionally one or more additive selected from stabilizers, pigments, mold release agents, flow enhancers, or antistatic agents. Said carbonate polymer blend composition has a good balance of physical properties, impact resistance, process-ability, and reduced gloss in molded articles.

### FIELD OF THE INVENTION

This invention relates to polymer compositions comprising a carbonate polymer, a propylene polymer, a compatibilizing graft copolymer, and a graft modified propylene polymer and/or an alpha-olefin carboxylic acid copolymer and/or an olefin block copolymer, and methods of preparation of such compositions. This invention relates particularly to a carbonate blend composition which demonstrates a good balance of physical properties, impact resistance, processability, and reduced gloss in molded articles especially with a grained surface.

### BACKGROUND OF THE INVENTION

Many thermoplastics have a natural, high gloss finish when injection molded, particularly compositions containing polymers such as polycarbonate (PC) or styrenics such as emulsion polymerized acrylonitrile, butadiene, and styrene terpolymers (ABS). For many applications, high gloss is a very desirable characteristic and it may be one of the most important factors in the selection of the material. On the other hand, for many other applications, such as automotive interior applications and information technology equipment, for example computer and other electronic equipment enclosures, there is a trend toward matte or low gloss finishes, principally for aesthetic reasons as well as for the elimination of costly coating and painting steps.

There is a recent trend toward formed articles with a non-coated finish, such as automotive interior trims and instrument panels, for the purpose of reducing production costs and giving improved safety, as well as relaxed feeling, by reducing light reflection. In addition, the recent tendency in automotive applications to produce several interior parts, for example an instrument panel, air bag cover and knee holster, from the same material creates demand for materials well-balanced in impact resistance and stiffness so as to meet minimum safety requirements which demonstrates a good balance of physical properties, impact resistance, processability, and reduced gloss in molded articles. Such molded articles may have a grained surface structure to drive down the gloss of the article. Grain type is typically dependent on the article and OEM.

Polycarbonate demonstrates a high level of heat resistance, impact strength, and dimensional stability with good insulating and non-corrosive properties. However, in addition to high gloss, polycarbonate is difficult to mold and suffers from an inability to fill thinwalled injection molded articles. This disadvantage has been somewhat relieved by decreasing the molecular weight of the polycarbonate to lower its viscosity. However, its gloss is often increased and its ductility is often reduced as a result. The reduction in ductility has been alleviated to some extent by the practice of blending polycarbonate with emulsion or core-shell elastomers such as methacrylate, butadiene, and styrene copolymer or a butyl acrylate rubber. However, these core shell rubbers hinder processability of the blend by increasing viscosity and do not help to lower gloss.

Polycarbonate has successfully been blended with various thermoplastic polymers to lower the viscosity of the blend and still maintain a good balance of physical and thermal properties. PC/ABS blends are a good example. However, PC/ABS blends retain similar high gloss appearance as PC alone even on articles with grained surface finishes. Polycarbonates have been blended with polyolefins (PO). PC/PO blends also have reduced viscosity as compared to PC alone. However, one of the resulting disadvantages with blending polycarbonate with an olefin polymer, is the tendency to delaminate which results in a reduction of impact resistance, toughness, and weldline strength of the blended polycarbonate.

References are known which disclose compositions of a blend of a polycarbonate and a styrene and acrylonitrile copolymer grafted to an ethylene, propylene, and optional diene copolymer such as U.S. Pat. No. 4,550,138. Further, the practice of blending polycarbonate with a polyolefin and an ethylene-propylene-diene terpolymer is discussed in U.S. Pat. No. 4,638,033. However the tertiary polymer blend compositions disclosed in U.S. Pat. No. 4,638,033 are taught to be especially useful for the production of molded parts having glossy surfaces.

It would be highly desirable to provide a polycarbonate polymer blend composition which exhibits a good balance of physical properties, impact resistance, processability, and reduced gloss in molded articles.

### SUMMARY OF THE INVENTION

The present invention is such a desirable material. The present invention is a carbonate polymer blend composition having a desirable balance of physical properties, impact resistance, processability, and reduced gloss in molded articles especially with grained surface finish.

In one embodiment, the present invention is a is a carbonate polymer blend composition comprising (a) a carbonate polymer, (b) a propylene polymer, (c) a compatibilizing graft copolymer, (d) a polymer selected from a graft modified propylene polymer (d.i), and/or an olefin-carboxylic acid copolymer (d.ii), and/or olefin block copolymer (d.iii) comprising one or more hard segment and one or more soft segment and characterized by one or more of the aspects described as follows:
(d.iii.a) has a weight average molecular weight/number average molecular weight ratio (Mw/Mn) from about 1.7 to about 3.5, at least one melting point (Tm) in degrees Celsius, and a density (d) in grams/cubic centimeter (g/cc), wherein the numerical values of Tm and d correspond to the relationship:

Tₘ>−2002.9+4538.5(d)−2422.2(d)² or Tₘ>−6553.3+13735(d)−7051.7(d)²; or
(d.iii.b) has a Mw/Mn from about 1.7 to about 3.5, and is characterized by a heat of fusion (ΔH) in Jules per gram (J/g) and a delta quantity, ΔT, in degrees Celsius defined as the temperature difference between the tallest differential scanning calorimetry (DSC) peak and the tallest crystallization analysis fractionation (CRYSTAF) peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or
(d.iii.c) is characterized by an elastic recovery (Re) in percent at 300 percent strain and 1 cycle measured with a compression-molded film of the ethylene/alpha-olefin interpolymer, and has a density (d) in grams/cubic centimeter (glee), wherein the numerical values of Rc and d satisfy the following relationship when ethylene/alpha-olefin interpolymer is substantially free of a cross-linked phase:

Re>1481−1629(d); or
(d.iii.d) has a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density, and molar comonomer content (based on the whole polymer) within 10 percent of that of the ethylene/alpha-olefin interpolymer; or
(d.iii.e) has a storage modulus at 25° C. (G′(25° C.)) and a storage modulus at 100° C. (G′(100° C.)) wherein the ratio of G′(25° C.) to 6′(100° C.) is in the range of about 1:1 to about 9:1 or
(d.iii.f) has a molecular fraction which elutes between 40° C. and 130° C. when fractionated using TREF, characterized in that the fraction has a block index of at least 0.5 and up to about 1 and a molecular weight distribution, Mw/Mn, greater than about 1.3; or
(d.iii.g) has an average block index greater than zero and up to about 1.0 and a molecular weight distribution, Mw/Mn, greater than about 1.3,
   (e) optionally a filler, (f) optionally a thermoplastic or elastomeric resin other than (a), (b), (c), or (d) and (g) optionally one or more additive selected from stabilizers, pigments, mold release agents, flow enhancers, or antistatic agents.

In a further embodiment of the present invention the propylene polymer preferably is a homopolymer of propylene or a copolymer of propylene and a C₂ or C₄ to C₂₀ alpha-olefin; preferably the compatibilizing graft copolymer is an EPDM-g-SAN polymer; preferably the graft modified propylene polymer is a PP-g-PMMA polymer; preferably the olefin-carboxylic acid copolymer is an EAA copolymer; preferably the olefin block copolymer is a copolymer of ethylene with propylene, 1-butene, 1-hexene, or 1-octene having a density of from 0.85 to 0.895 g/cc, and/or an I₂/I₁₀ of from 5 to 35, and/or an average block index of from 0.15 to 0.8 and/or a molecular weight distribution (Mw/Mn) of from 1.9 to 7 and/or a soft segment content by weight percent of from 40 to 95; preferably the filler is talc, wollastonite, clay, single layers of a cation exchanging layered silicate material or mixtures thereof; and preferably the additional polymer is selected from low density polyethylene, linear low density polyethylene, high density polyethylene, substantially linear ethylene polymer, linear ethylene polymer, polystyrene, polycyclohexylethane, polyester, ethylene/styrene interpolymer, syndiotactic polypropylene, syndiotactic polystyrene, ethylene/propylene copolymer, hydrogenated vinyl aromatic based copolymers and block copolymers, non-hydrogenated vinyl aromatic based copolymers and block copolymers, ethylene/butylene copolymer, ethylene/alpha olefin copolymer, ethylene/propylene/diene terpolymer, or mixtures thereof.

Another embodiment of the present invention is a method to prepare the abovementioned carbonate polymer blend composition by combining (a) a carbonate polymer, (h) a propylene polymer, (c) a compatibilizing graft copolymer, (d) a polymer selected from a graft modified propylene polymer and/or an olefin-carboxylic acid copolymer, and/or an olefin block copolymer, (e) optionally a filler, (f) optionally a thermoplastic resin other than (a), (b), (c), or (d) and (g) optionally one or more additive selected from stabilizers, pigments, mold release agents, flow enhancers, or antistatic agents.

Another embodiment of the present invention is a method for producing a molded or extruded article of a carbonate polymer blend composition comprising the steps preparing a carbonate polymer blend composition and molding or extruding said carbonate polymer blend composition into a molded or an extruded article.

Another embodiment of the present invention is the abovementioned carbonate polymer blend composition in the form of a molded or an extruded article, preferably an automotive bumper beam, an automotive bumper fascia, an automotive pillar, an automotive instrument panel, automotive interior trim, automotive interior overhead consoles, automotive interior bezels, knee bolsters, steering column cowls, glove box trim, an electrical equipment device housing, an electrical equipment device cover, an appliance housing, a freezer container, a crate, or lawn and garden furniture.

### DETAILED DESCRIPTION OF THE EMBODIMENTS

Component (a) in the carbonate polymer blend composition of the present invention is a carbonate polymer. Carbonate polymers are well known in the literature and can be prepared by known techniques, for example several suitable methods are disclosed in U.S. Pat. Nos. 3,028,365, 4,529,791, and 4,677,162, which are hereby incorporated by reference in their entirety. In general, carbonate polymers can be prepared from one or more multihydric compounds by reacting the multihydric compounds, preferably an aromatic dihydroxy compound such as a diphenol, with a carbonate precursor such as phosgene, a haloformate or a carbonate ester such as diphenyl or dimethyl carbonate. Preferred diphenols are 2,2-bis(4-hydroxyphenyl)-propane, 1,1-bis(4-hydroxyphenyl)-1-phenylethane, 3,3-bis(para-hydroxyphenyl)phthalide and bishydroxyphenylfluorene. The carbonate polymers can be prepared from these raw materials by any of several known processes such as the known interfacial, solution or melt processes. As is well known, suitable chain terminators and/or branching agents can be employed to obtain the desired molecular weights and branching degrees.

It is understood, of course, that the carbonate polymer may be derived from (1) two or more different dihydric phenols or (2) a dihydric phenol and a glycol or a hydroxy- or acid-terminated polyester or a dibasic acid in the event a carbonate copolymer or heteropolymer rather than a homopolymer is desired. Thus, included in the term “carbonate polymer” are the poly(ester-carbonates) of the type described in U.S. Pat. Nos. 3,169,121, 4,156,069, and 4,260,731, which are hereby incorporated by reference in their entirety. Also suitable for the practice of this invention are blends of two or more of the above carbonate polymers. Of the aforementioned carbonate polymers, the polycarbonates of bisphenol-A are preferred.

The carbonate polymer is employed in the carbonate polymer blend compositions of the present invention in amounts sufficient to provide the desired balance of physical properties, impact resistance, processability, and reduced gloss in molded articles. In general, the carbonate polymer is employed in amounts of at least about 10 parts by weight, preferably at least about 25 parts by weight, and most preferably at least about 50 parts by weight based on the total weight of the carbonate polymer blend composition. In general, the carbonate polymer is used in amounts less than or equal to about 90 parts by weight, preferably less than or equal to about 75 parts by weight, and most preferably less than or equal to about 65 parts by weight based on the total weight of the carbonate polymer blend composition.

Component (b) in the carbonate polymer blend composition of the present invention is a propylene polymer. The propylene polymer suitable for use in this invention is well known in the literature and can be prepared by known techniques. In general, the propylene polymer is in the isotactic form, although other forms can also be used (e.g., syndiotactic or atactic). The propylene polymer used for the present invention is preferably a homopolymer of polypropylene or more preferably a copolymer, for example, a random or block copolymer, of propylene and an alpha-olefin, preferably a C₂ or C₄ to C₂₀alpha-olefin. The alpha-olefin is present in the propylene copolymer of the present invention in an amount of not more than 20 percent by mole, preferably not more than 15 percent, even more preferably not more than 10 percent and most preferably not more than 5 percent by mole.

Examples of the C₂ and C₄ to C₂₀ alpha-olefins for constituting the propylene and alpha-olefin copolymer include ethylene, 1-butene, 1-pentene, 1-hexene, 1-heptene, 1-octene, 1-decene, 1-dodecene, 1-hexadodecene, 4-methyl-1-pentene, 2-methyl-1-butene, 3-methyl-1-butene, 3,3-dimethyl-1-butene, diethyl-1-butene, trimethyl-1-butene, 3-methyl-1-pentene, ethyl-1-pentene, propyl-1-pentene, dimethyl-1-pentene, methylethyl-1-pentene, diethyl-1-hexene, trimethyl-1-pentene, 3-methyl-1-hexene, dimethyl-1-hexene, trimethyl-1-hexene, methylethyl-1-heptene, trimethyl-1-heptene, dimethyloctene, ethyl-1-octene, methyl-1-nonene, vinylcyclopentene, vinylcyclohexene and vinylnorbornene, where alkyl branching position is not specified it is generally on position 3 or higher of the alkene.

Propylene polymers suitable for use in the present invention can be prepared by various processes, for example, in a single stage or multiple stages, by such polymerization method as slurry polymerization, gas phase polymerization, bulk polymerization, solution polymerization or a combination thereof using a metalloccne catalyst or a so-called Ziegler-Nana catalyst, which usually is one comprising a solid transition metal component comprising titanium. Particularly a catalyst consisting of, as a transition metal/solid component, a solid composition of titanium trichloride which contains as essential components titanium, magnesium and a halogen; as an organometallic component an organoaluminum compound; and if desired an electron donor. Preferred electron donors are organic compounds containing a nitrogen atom, a phosphorous atom, a sulfur atom, a silicon atom or a boron atom, and preferred are silicon compounds, ester compounds or ether compounds containing these atoms.

A good discussion of various propylene polymers is contained in Modern Plastics Encyclopedia/89, mid October 1988 Issue, Volume 65, Number 11, pp. 86-92, the entire disclosure of which is incorporated herein by reference. The molecular weight of the propylene polymer for use in the present invention is conveniently indicated using a melt flow measurement, sometimes referred to as melt flow rate (MFR) or melt index (ML), according to ASTM D 1238 at 230° C. and an applied load of 2.16 kilogram (kg). Melt flow rate is inversely proportional to the molecular weight of the polymer. Thus, the higher the molecular weight, the lower the melt flow rate, although the relationship is not linear. The melt flow rate for the propylene polymer useful herein is generally greater than about 0.1 grams/10 minutes (g/10 min), preferably greater than about 0.5 g/10 min, more preferably greater than about 1 g/10 min, and even more preferably greater than about 10 g/10 min The melt flow rate for the propylene polymer useful herein is generally less than about 200 g/10 min, preferably less than about 100 g/10 min, more preferably less than about 75 g/10 min, and more preferably less than about 50 g/10 min.

The propylene polymer is employed in the carbonate polymer blend compositions of the present invention in amounts sufficient to provide the desired balance of physical properties, impact resistance, processability, and reduced gloss in molded articles. In general, the propylene polymer is employed in amounts equal to or greater than about 10 parts by weight, preferably equal to or greater than about 12 parts by weight, and most preferably equal to or greater than about 14 parts by weight based on the total weight of the low gloss carbonate polymer blend composition. In general, the propylene polymer is used in amounts less than or equal to about 90 parts by weight, preferably less than or equal to about 70 parts by weight, and most preferably less than or equal to about 40 parts by weight based on the total weight of the carbonate polymer blend composition.

Component (c) in the carbonate polymer blend composition of the present invention is a compatibilizing graft copolymer. The compatibilizing graft copolymer comprises a copolymer component (sometimes referred to as “grafted copolymer component”) grafted onto an olefinic polymer substrate component, preferably an olefin elastomer component. The grafted copolymer component preferably comprises copolymers of monovinylidene aromatic monomers, especially styrene (also substituted styrenes such as alpha-methylstyrene), with one or more additional unsaturated, copolymerizable monomers, preferably ethylene, methyl methacrylate, maleic anhydride, or more preferably the ethylenically unsaturated nitrile monomers (such as acrylonitrile and/or methacrylonitrile). A preferred graft copolymer comprises a vinylaromatic co-polymer grafted olefin elastomer, a more preferred graft copolymer comprises a styrene and acrylonitrile copolymer with styrene/acrylonitrile monomer ratios in the range of from about 90/10 to about 40/60, preferably from about 90/10 to about 50/50, and most preferably from about 80/20 to about 60/40. Preferred compatibilizing graft copolymer components suitable for use in the compositions according to the present invention comprise a grafted copolymer component of styrene and acrylonitrile in amounts of at least about 5 parts, preferably at least about 30 parts, and more preferably at least about 40 parts by weight, based on the total weight of the compatibilizing graft copolymer with the balance being the olefinic polymer substrate component. The compatibilizing graft copolymers suitable for use in compositions of the present invention comprise a grafted copolymer component preferably of styrene and acrylonitrile in amounts of less than or equal to about 75 parts, preferably less than or equal to about 70 parts, and more preferably less than or equal to about 60 parts by weight, based on a total weight of the compatibilizing graft copolymer with the balance being the olefinic polymer substrate component.

The copolymer component is grafted onto an olefinic polymer substrate component such as one or more substantially linear ethylene polymer or linear ethylene polymer, preferably an ethylenically unsaturated site in the backbone of an olefinic homopolymer such as ethylene or propylene, preferably a copolymer of ethylene and one or more C, to C₂₀ alpha-olefin, more preferably an ethylene and monovinyhdene aromatic copolymer, even more preferably an ethylene, propylene, and optional diene copolymer, or most preferably an ethylene, propylene, and non-conjugated diene terpolymer (“EPDM”), wherein a preferred non-conjugated diene is dicyclopentadiene, more preferably 1-4-hexadiene, and even more preferably ethyl idene norbornene. A preferred ethylene, propylene, and non-conjugated diene terpolymer to which the graft copolymer is attached is characterized by a weight ratio of ethylene to propylene in the range of between about 50/50 and about 75/25 and preferably possesses an intrinsic viscosity, as measured in tetralin at 135° C. (275° F.), in the range of between about 1.5 and about 2.6. The Mooney Viscosity (ML-4 at 275° F.) of the rubber portion is in the range of between about 30 to about 100. Typically, the ungrafted rubber is defined by an Iodine number in the range of between about 4 and about 30.

A preferred compatibilizing graft copolymer of the present invention comprises a copolymer of styrene and acrylonitrile grafted onto an ethylene, propylene, and non-conjugated diene terpolymer (“EPDM-g-SAN polymer”).

The method by which the graft copolymer is preferably formed, that is, the method by which the preferred styrene and acrylonitrile copolymer is grafted onto the preferred ethylene, propylene, and non-conjugated diene terpolymer is generally known in the art and is set forth in detail in U.S. Pat. No. 3,489,821; U.S. Pat. No. 3,489,822; and U.S. Pat. No. 3,642,950. It will be understood that in practice the product of the graft copolymerization process is actually a mixture of true grafted copolymer component onto the olefinic polymer substrate component along with a certain amount of separate, ungrafted copolymer component (that is, the grafting efficiency is not 100 percent). Alternatively, the graft copolymer as described above can be added to a non-grafted olefin polymer of same or similar composition to form the grafted copolymer component.

The compatibilizing graft copolymer is employed in the carbonate polymer blend compositions of the present invention in amounts sufficient to provide the desired balance of physical properties, impact resistance, processability, and reduced gloss in molded articles. In general, the compatibilizing graft copolymer is employed in amounts of equal to or greater than about 2 part by weight, preferably equal to or greater than about 4 part by weight, and most preferably equal to or greater than about 8 parts by weight based on the total weight of the carbonate polymer blend composition. In general, the compatibilizing graft copolymer is used in amounts less than or equal to about 30 parts by weight, preferably less than or equal to about 20 parts by weight, and most preferably about 16 parts by weight based on the total weight of the carbonate polymer blend composition.

Component (d) in the carbonate polymer blend composition of the present invention may be (d)(i) a graft modified propylene polymer preferably an acrylate graft modified propylene polymer, more preferably a polymethyl methacrylate graft modified propylene polymer (“PP-g-PMMA polymer”) and/or (d)(ii) an alpha-olefin carboxylic acid copolymer, preferably ethylene acrylic acid copolymer (“EAA copolymer”) and/or (d)(iii) an olefin block copolymer. Suitable graft modification of a propylene polymer (d)(i) is achieved with any unsaturated organic compound containing, in addition to at least one ethylenic unsaturation (e.g., at least one double bond), at least one carbonyl group (—C═O) and that will graft to a polypropylene as described above. Representative of unsaturated organic compounds that contain at least one carbonyl group are the carboxylic acids, anhydrides, esters and their salts, both metallic and nonmetallic. Preferably, the organic compound contains ethylenic unsaturation conjugated with a carbonyl group. Representative compounds include maleic, fumaric, acrylic, methacrylic, itaconic, crotonic, -methyl crotonic, and cinnamic acid and their anhydride, ester and salt derivatives, if any. Methyl methacrylate is the preferred unsaturated organic compound containing at least one ethylenic unsaturation and at least one carbonyl group.

The unsaturated organic compound containing at least one carbonyl group can be grafted to the propylene polymer by any known technique, such as those taught in U.S. Pat. No. 3,236,917 and U.S. Pat. No. 5,194,509. For example, polymer powder is introduced into a batch mixer and mixed at a temperature of 70° C. The unsaturated organic compound is then added along with a free radical initiator, such as, for example, benzoyl peroxide, and the components are mixed at 70° C. until the grafting is completed. This method produces fewer grafts, but the grafts are of higher molecular weight. Alternatively, the reaction temperature is higher, e.g., 210° C. to 300° C., and a free radical initiator is not used or is used at a reduced concentration. This method produces a large number of grafts, and consequently the grafts are lower in molecular weight. A high temperature method of grafting is taught in U.S. Pat. No. 4,905,541, the disclosure of which is incorporated herein by reference, by using a twin-screw devolatilizing extruder as the mixing apparatus. The polypropylene and unsaturated organic compound are mixed and reacted within the extruder at temperatures at which the reactors are molten and in the presence of a free radical initiator. Preferably, the unsaturated organic compound is injected into a zone maintained under pressure in the extruder. The present invention can use graft modified propylene polymer prepared from either or both graft techniques. Preferably, the graft modified propylene polymer is prepared using the low temperature hatch grafting technique.

As defined herein, a propylene polymer (PP) grafted with one or more (P) acrylate monomer (AM) is described by the abbreviation PP-g-PAM, wherein the P represents one or more (poly) acrylate monomer. For example, if the acrylate monomer is one or more methyl methacrylate monomer then the abbreviation is PP-g-PMMA, if the acrylate is one or more acrylic acid monomer then the abbreviation is PP-g-PAA.

The unsaturated organic compound content of the grafted polypropylene is equal to or greater than about 0.1 weight percent, preferably equal to or greater than about 1 weight percent, more preferably equal to or greater than about 2 weight percent, and most preferably equal to or greater than about 5 weight percent based on the combined weight of the propylene polymer and organic compound. The maximum amount of unsaturated organic compound content can vary to convenience, but typically it does not exceed about 25 weight percent, preferably it does not exceed about 20 weight percent, more preferably it does not exceed about 15 weight percent and most preferably it does not exceed about 12 weight percent based on the combined weight of the propylene polymer and the organic compound.

Suitable alpha-olefin carboxylic acid copolymers (d)(ii) employed in the present invention are copolymers of ethylenically unsaturated acids with alpha-olefins with having the general formula:

R¹—CH═CH₂

where R¹ is a radical selected from the class consisting of hydrogen and alkyl radicals having from 1 to 8 carbon atoms, the olefin content of said copolymer being at least 50 mol percent based on the polymer, and an α,β-ethylenically unsaturated carboxylic acid having 1 or 2 carboxylic acid groups, the acid monomer content of said copolymer being from 0.2 to 25 mol percent based on the copolymer, said carboxylic acid being uniformly distributed throughout the copolymer.

Suitable alpha-olefins include ethylene, propylene, butane-1, pentene-1, hexane-1, heptene-1,3-methylpentene-1, etc. Although polymers of olefins having higher carbon numbers can be employed in the present invention, they are not materials which are readily obtained or available. The concentration of the alpha-olefin is preferably equal to or greater than about 50 mol percent in the copolymer, and is more preferably equal to or greater than about 80 mol percent.

Suitable α,β-ethylenically unsaturated carboxylic acid monomers are acrylic acid, methacrylic acid, ethacrylic acid, itaconic acid, maleic acid, fumaric acid, monoesters of said dicarboxylic acids, such as methyl hydrogen maleate, methyl hydrogen fumerate, ethyl hydrogen fumerate and maleic anhydride. Although maleic anhydride is not a carboxylic acid in that is has no hydrogen attached to the carboxyl groups, it can be considered an acid for the purposes of the present invention because of its chemical reactivity being that of an acid. Similarly, other α,β-monoethylenically unsaturated anhydrides of carboxylic acids can be employed. As indicated, the concentration of acidic monomer in the copolymer is from about 0.2 mol percent to about 25 mol percent, and preferably, from about 1 to about 10 mol percent.

The alpha-olefin carboxylic acid copolymers employed in forming the compositions of the present invention may be prepared in several ways. Thus, the alpha-olefin carboxylic acid copolymers may be obtained by the copolymerization of a mixture of the alpha-olefin and carboxylic acid monomer. This method is preferred for the copolymers of ethylene employed in the present invention. Methods employed for the preparation of ethylene carboxylic acid copolymers have been described in the literature. However, as pointed out further hereinafter, the preferred products are those obtained from base copolymers in which the carboxylic acid groups are randomly distributed over all of the copolymer molecules. In brief, that technique required carrying out the copolymerization of the alpha-olefin and the carboxylic acid monomers in a single phase environment, i.e. one in which the monomers are soluble, e.g. benzene or ethylene, which may be in liquid or vaporized form. Preferably, and especially when relatively small amounts of the carboxylic acid component are desired in the base copolymer, the process is continuous, the monomers being fed to the reactor in the ratio of their relative polymer-forming reactivities and residence time in the reactor being limited so that from about 3-20 percent of the ethylene-monomer feed is converted to polymer. In a preferred process, a mixture of the two monomers is introduced into a polymerization environment maintained at high pressures, 50 to 3000 atmospheres, and elevated temperatures, 150° C. to 300° C., together with a free radical polymerization initiator such as peroxide.

Copolymers of alpha-olefins with carboxylic acids may also be prepared by copolymerization of the olefin with an α,β-ethylenically unsaturated carboxylic acid derivative whish subsequently or during copolymerization is re-acted either completely or in part to form the free acid. Thus, hydrolysis, saponification or pyrolysis may be employed to form an acid copolymer from en ester copolymer. It is preferable to employ a copolymer containing the carboxylic acid groups randomly distributed over all molecules. Such random distribution is best obtained by direct copolymerization. The alpha-olefin carboxylic acid copolymers of the present invention may further comprise a third non-reactive monomer.

The alpha-olefin carboxylic acid copolymers employed are preferably of high molecular weight. The molecular weight of the copolymers useful as base resins is most suitably defined by melt index, a measure of viscosity, described in detail in ASTM-D-1238 (190° C./2160 g). The melt index of copolymers employed in the formation of compositions is preferably in the range of 0.1 to 1000 g/10 min and, more particularly, in the range of 1.0 to 100 g/1.0 min.

The alpha-olefin carboxylic acid copolymer need not necessarily comprise a two component polymer. Thus, although the olefin content of the copolymer should be at least 50 mol percent, more than one olefin can be employed to provide the hydrocarbon nature of the copolymer base. Additionally, other copolymerizable monoethylenically unsaturated monomers, illustrative members of which are mentioned below in this paragraph, can be employed in combination with the olefin and the carboxylic acid comonomer. The scope of alpha-olefin carboxylic acid copolymers suitable for use in the present invention is illustrated by the following examples: ethylene/acrylic acid copolymers, ethylene/methacrylic acid copolymers, ethylene/itaconic acid copolymers, ethylene/methyl hydrogen maleate copolymers, ethylene/maleic acid copolymers, ethylene/acrylic acid/methyl methacrylate copolymers, ethylene/methacrylic acid/ethyl acrylate copolymers, ethylene/itaconic acid/methyl methacrylate copolymers, ethylene/methyl hydrogen maleate/ethyl acrylate copolymers, ethylene/methacrylic acid/vinyl acetate copolymers, ethylene/acrylic acid/vinyl alcohol copolymers, ethylene/propylene/acrylic acid copolymers, ethylene/styrene/acrylic acid copolymers, ethylene/methacrylic acid/acrylonitrile copolymers, ethylene/fumaric acid/vinyl methyl ether copolymers, ethylene/vinyl chloride/acrylic acid copolymers, ethylene/vinyl idene chloride/acrylic acid copolymers, ethylene/vinyl fluoride/methacrylic acid copolymers, and ethylene/chlorotrifluoroethylene/methacrylic acid copolymers.

The alpha-olefin carboxylic acid copolymers used in the composition of the present invention are free of metal ions, containing essentially no metal ions, for example, consisting of olefin and carboxylic acid units.

A preferred alpha-olefin carboxylic acid copolymer of the present invention is an ethylene-methacrylic acid copolymer (“EMMA copolymer”).

A preferred alpha-olefin carboxylic acid copolymer of the present invention is an ethylene acrylic acid copolymers (“EAA copolymer”). The preferred EAA copolymers used in the present invention are characterized as a random interpolymers prepared at high pressure by the action of a free-radical polymerization initiator, acting on a mixture of ethylene and acrylic acid monomers, said random interpolymer being further characterized as containing from about 0.5 to about 50 weight percent of the acrylic acid moiety, a density in the range of from about 0.91 to about 1.3 glee, and a melt flow value of from about 150 g/10 min as measured by ASTM D-1238 (Condition B) to about 0.1 g/10 min as measured by ASTM D-1238 (Condition E). The EAA copolymers used in the present novel blends are more precisely referred to as “interpolymers” because they are formed by the polymerization of a mixture of the comonomers, in contradistinction to copolymers made by “grafting” or “block-polymerization” methods. Patents which disclose interpolymerizations of ethylene and unsaturated carboxylic acids in a steady state reaction at high pressure and high temperature in a stirred reactor in the presence of a free-radical initiator are: U.S. Pat. Nos. 4,351,931; 3,239,370; 3,520,861; 3,658,741; 3,884,857; 3,988,509; 4,248,990; 4,252,924; 4,417,035; and 4,599,392; all of which are incorporated herein by reference.

Preferred EAA copolymer having a melt flow rate in the range of from about 0.1 to about 5000 g/10 minutes, as determined by ASTM D-1238 (190.degree. C./2160 g), are improved during manufacture when made in a substantially constant environment in a stirred autoclave under substantially steady-state conditions of temperature, pressure, and flow rates, said temperature and pressure being sufficient to produce a single phase reaction, using a free-radical initiator, said improvement being obtained by the use of a minor amount of a telogenic modifier in the reaction mixture, the process being further characterized by the use of either, or both, of (a) a temperature which is lower than that which would be required without the presence of the telogen, or (b) a pressure which is higher than that which would be required without the presence of the modifier. Preferred EAA copolymers are disclosed in U.S. Pat. Nos. 4,988,781 and 5,384,373, both of which are incorporated herein by reference.

Suitable olefin block copolymers (d)(iii) employed in the present invention are ethylene/alpha-olefin interpolymers which comprise ethylene and one or more copolymerizable alpha-olefin comonomers in polymerized form, characterized by multiple blocks or segments of two or more polymerized monomer units differing in chemical or physical properties (block interpolymer), preferably a multi-block copolymer, such as described in U.S. Pat. No. 7,355,089 and USP Application Publication No. 2006-0199930, which are herein incorporated by reference.

The term “ethylene/alpha-olefin interpolymer” generally refers to polymers comprising ethylene and an alpha-olefin having 3 or more carbon atoms, such as propylene or other C₄ to C₂₀ alpha-olefins disclosed hereinabove. Preferred alpha-olefins are propylene, 1-butene, 1-pentene, 1-hexene, 1-heptene, 1-decene, 1-dodecene, and most preferred is 1-octane. Preferably, ethylene comprises the majority mole fraction of the whole polymer, i.e., ethylene comprises at least about 50 mole percent of the whole polymer. More preferably ethylene comprises at least about 60 mole percent, at least about 70 mole percent, or at least about 80 mole percent, with the substantial remainder of the whole polymer comprising at least one other comonomer that is preferably an alpha-olefin having 3 or more carbon atoms. For many ethylene/octene copolymers, the preferred composition comprises an ethylene content greater than about 80 mole percent of the whole polymer and an octene content of from about 10 to about 15, preferably from about 15 to about 20 mole percent of the whole polymer.

The term “multi-block copolymer” refers to a polymer comprising two or more chemically distinct regions or segments (also referred to as “blocks”) preferably joined in a linear manner, that is, a polymer comprising chemically differentiated units which arc joined end-to-end with respect to polymerized ethylenic functionality, rather than in pendent or grafted fashion. In a preferred embodiment, the blocks differ in the amount or type of comonomer incorporated therein, the density, the amount of crystallinity, the crystallite size attributable to a polymer of such composition, the type or degree of tacticity (isotactic or syndiotactic), regio-regularity or regio-irregularity, the amount of branching, including long chain branching or hyper-branching, the homogeneity, or any other chemical or physical property. The multi-block copolymers are characterized by unique distributions of both polydispersity index (PDI or M.sub.w/M.sub.n), block length distribution, and/or block number distribution due to the unique process making of the copolymers. More specifically, when produced in a continuous process, the polymers desirably possess PDI from about 1.7 to about 8, preferably from about 1.7 to about 3.5, more preferably from about 1.7 to about 2.5, and most preferably from about 1.8 to about 2.5 or from about 1.8 to about 2.1. When produced in a batch or semi-batch process, the polymers possess PDI from about 1.0 to about 2.9, preferably from about 1.3 to about 2.5, more preferably from about 1.4 to about 2.0, and most preferably from about 1.4 to about 1.8. It is noted that “block(s)” and “segment(s)” are used herein interchangeably.

The olefin block copolymers (d.iii) of the present invention are an alpha-olefin interpolymer, specifically an alpha-olefin block copolymer comprising one or more hard segment and one or more soft segment and characterized by one or more of the aspects described as follows:

(d.iii.a) has a weight average molecular weight/number average molecular weight ratio (Mw/Mn) from about 1.7 to about 3.5, at least one melting point (Tm) in degrees Celsius, and a density (d) in grams/cubic centimeter (glee), wherein the numerical values of Tm and d correspond to the relationship:

Tₘ>−2002.9+4538.5(d)−2422.2(d)² or Tₘ>−6553.3+13735(d)−7051.7(d)²; or

(d.iii.b) has a Mw/Mn from about 1.7 to about 3.5, and is characterized by a heat of fusion (ΔH) in Jules per gram (J/g) and a delta quantity, ΔT, in degrees Celsius defined as the temperature difference between the tallest differential scanning calorimetry (DSC) peak and the tallest crystallization analysis fractionation (CRYSTAF) peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or

(d.iii.c) is characterized by an elastic recovery (Re) in percent at 300 percent strain and 1 cycle measured with a compression-molded film of the ethylene/alpha-olefin interpolymer, and has a density (d) in grams/cubic centimeter (g/cc), wherein the numerical values of Re and d satisfy the following relationship when ethylene/alpha-olefin interpolymer is substantially free of a cross-linked phase:

Re>1481−1629(d); or

(d.iii.d) has a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density, and molar comonomer content (based on the whole polymer) within 10 percent of that of the ethylene/alpha-olefin interpolymer; or

(d.iii.e) has a storage modulus at 25° C. (G′(25° C.)) and a storage modulus at 100° C. (G′(100° C.)) wherein the ratio of G′(25° C.) to G′(100° C.) is in the range of about 1:1 to about 9:1 or

(d.iii.f) has a molecular fraction which elutes between 40° C. and 130° C. when fractionated using TREF, characterized in that the fraction has a block index of at least 0.5 and up to about 1 and a molecular weight distribution, Mw/Mn, greater than about 1.3; or

(d.iii.g) has an average block index greater than zero and up to about 1.0 and a molecular weight distribution, Mw/Mn, greater than about 1.3.

Processes for making the ethylene/alpha-olefin interpolymers have been disclosed in, for example, the following patent applications and publications: U.S. Provisional Application Nos. 60/553,906, filed Mar. 17, 2004; 60/662,937, filed Mar. 17, 2005; 60/662,939, filed Mar. 17, 2005; 60/566,2938, filed Mar. 17, 2005; PCT Application Nos. PCT/US2005/008916, filed Mar. 17, 2005; PCT/US 2005/008915, filed Mar. 17, 2005; PCT/US2005/008917, filed Mar. 17, 2005; WO 2005/090425, published Sep. 29, 2005; WO 2005/090426, published Sep. 29, 2005; and WO 2005/090427, published Sep. 29, 2005, all of which are incorporated by reference herein in their entirety. For example, one such method comprises contacting ethylene and optionally one or more addition polymerizable monomers other than ethylene under addition polymerization conditions with a catalyst composition comprising the admixture or reaction product resulting from combining:

(A) a first olefin polymerization catalyst having a high comonomer incorporation index,

(B) a second olefin polymerization catalyst having a comonomer incorporation index less than 90 percent, preferably less than 50 percent, most preferably less than 5 percent of the comonomer incorporation index of catalyst (A), and

(C) a chain shuttling agent.

The following test methods are used to characterize the olefin block copolymers of the present invention and are discussed in further detail in U.S. Pat. No. 7,355,089 and USP Publication No. 2006/0199930:

“Standard CRYSTAF method” or crystallization analysis fractionation is used to determine branching distributions. CRYSTAF is determined using a CRYSTAF 200 unit commercially available from PolymerChar, Valencia, Spain. The samples are dissolved in 1,2,4 trichlorobenzene at 160° C. (0.66 mg/mL) for 1 hr and stabilized at 95° C. for 45 minutes. The sampling temperatures range from 95 to 30° C. at a cooling rate of 0.2° C./min. An infrared detector is used to measure the polymer solution concentrations. The cumulative soluble concentration is measured as the polymer crystallizes while the temperature is decreased. The analytical derivative of the cumulative profile reflects the short chain branching distribution of the polymer.

The CRYSTAF peak temperature and area are identified by the peak analysis module included in the CRYSTAF Software (Version 2001.b, PolymerChar, Valencia, Spain). The CRYSTAF peak finding routine identifies a peak temperature as a maximum in the dW/dT curve and the area between the largest positive inflections on either side of the identified peak in the derivative curve. To calculate the CRYSTAF curve, the preferred processing parameters are with a temperature limit of 70° C. and with smoothing parameters above the temperature limit of 0.1, and below the temperature limit of 0.3.

“Flexural/Secant Modulus/Storage Modulus” samples are compression molded using ASTM D 1928. Flexural and 2 percent secant moduli are measured according to ASTM D-790. Storage modulus is measured according to ASTM D 5026-01 or equivalent technique.

“Melt Index” or I₂, is measured in accordance with ASTM D 1238, Condition 190° C./2.16 kg. Melt index, or I₁₀ is also measured in accordance with ASTM D 1238, Condition 190° C./10 kg. A useful value for comparison is the ratio I₁₀/I₂.

“DSC Standard Method” or Differential. Scanning Calorimetry results are determined using a TAI model Q1000 DSC equipped with an RCS cooling accessory and an autosampler. A nitrogen purge gas flow of 50 ml/min is used. The sample is pressed into a thin film and melted in the press at about 175° C. and then air-cooled to room temperature (25° C.). 3-10 mg of material is then cut into a 6 mm diameter disk, accurately weighed, placed in a light aluminum pan (ca 50 mg), and then crimped shut. The thermal behavior of the sample is investigated with the following temperature profile. The sample is rapidly heated to 180° C. and held isothermal for 3 minutes in order to remove any previous thermal history. The sample is then cooled to −40° C. at 10′C/min cooling rate and held at −40° C. for 3 minutes. The sample is then heated to 150° C. at 10° C./min heating rate. The cooling and second heating curves are recorded.

The DSC melting peak is measured as the maximum in heat flow rate (W/g) with respect to the linear baseline drawn between −30° C. and end of melting. The heat of fusion is measured as the area under the melting curve between −30° C. and the end of melting using a linear baseline.

Calibration of the DSC is done as follows. First, a baseline is obtained by running a DSC from −90° C. without any sample in the aluminum DSC pan. Then 7 milligrams of a fresh indium sample is analyzed by heating the sample to 180° C., cooling the sample to 140° C. at a cooling rate of 10° C./min followed by keeping the sample isothermally at 140° C. for 1 minute, followed by heating the sample from 140° C. to 180° C. at a heating rate of 10° C. per minute. The heat of fusion and the onset of melting of the indium sample are determined and checked to be within 0.5° C. from 156.6° C. for the onset of melting and within 0.5 J/g from 28.71 J/g for the of fusion. Then deionized water is analyzed by cooling a small drop of fresh sample in the DSC pan from 25° C. to −30° C. at a cooling rate of 1.0° C. per minute. The sample is kept isothermally at −30° C. for 2 minutes and heat to 30° C. at a heating rate of 10° C. per minute. The onset of melting is determined and checked to be within 0.5° C. from 0° C.

“GPC Method” is gel permeation chromatographic for molecular weight determinations. The system consists of either a Polymer Laboratories Model PL-210 or a Polymer Laboratories Model PL-220 instrument. The column and carousel compartments are operated at 140° C. Three Polymer Laboratories 10-micron Mixed-B columns are used. The solvent is 1,2,4 trichlorobenzene. The samples are prepared at a concentration of 0.1 grams of polymer in 50 milliliters of solvent containing 200 ppm of butylated hydroxytoluene (BHT). Samples are prepared by agitating lightly for 2 hours at 160° C. The injection volume used is 100 microliters and the flow rate is 1.0 ml/minute.

Calibration of the GPC column set is performed with 21 narrow molecular weight distribution polystyrene standards with molecular weights ranging from 580 to 8,400,000, arranged in 6 “cocktail” mixtures with at least a decade of separation between individual molecular weights. The standards arc purchased from Polymer Laboratories (Shropshire, UK). The polystyrene standards are prepared at 0.025 grams in 50 milliliters of solvent for molecular weights equal to or greater than 1,000,000, and 0.05 grams in 50 milliliters of solvent for molecular weights less than 1,000,000. The polystyrene standards are dissolved at 80° C. with gentle agitation for 30 minutes. The narrow standards mixtures are run first and in order of decreasing highest molecular weight component to minimize degradation. The polystyrene standard peak molecular weights are converted to polyethylene molecular weights using the following equation (as described in Williams and Ward, J. Polym. Sci., Polym. Let., 6, 621 (1968)): M_{polyethylene}=0.43 (M_{polystyrene}).

Polyethylene equivalent molecular weight calculations are performed using Viscotek TriSEC software Version 3.0.

“Density” measurement samples are prepared according to ASTM D 1928. Measurements are made within one hour of sample pressing using ASTM D792, Method B.

“ATREF” is analytical temperature rising elution fractionation analysis and is conducted according to the method described in U.S. Pat. No. 4,798,081 and Wilde, L.; Ryle, T. R.; Knobeloch, D. C.; Peat, I. R.; Determination of Branching Distributions in Polyethylene and Ethylene Copolymers, J. Polym. Sci., 20, 441-455 (1982), which are incorporated by reference herein in their entirety. The composition to be analyzed is dissolved in trichlorobenzene and allowed to crystallize in a column containing an inert support (stainless steel shot) by slowly reducing the temperature to 20° C. at a cooling rate of 0.1° C./min. The column is equipped with an infrared detector. An ATREF chromatogram curve is then generated by eluting the crystallized polymer sample from the column by slowly increasing the temperature of the eluting solvent (trichlorobenzene) from 20 to 120° C. at a rate of 1.5° C./min.

“¹³C NMR Analysis” samples are prepared by adding approximately 3 g of a 50/50 mixture of tetrachloroethane-d²/orthodichlorobenzene to 0.4 g sample in a 10 mm NMR tube. The samples are dissolved and homogenized by heating the tube and its contents to 150° C. The data are collected using a JEOL Eclipse™ 400 MHz spectrometer or a Varian Unity Plus™400 MHz spectrometer, corresponding to a ¹³C resonance frequency of 100.5 MHz. The data are acquired using 4000 transients per data file with a 6 second pulse repetition delay. To achieve minimum signal-to-noise for quantitative analysis, multiple data files are added together. The spectral width is 25,000 Hz with a minimum file size of 32K data points. The samples are analyzed at 130° C. in a 10 mm broad band probe. The comonomer incorporation is determined using Randall's triad method (Randall, J. C.; JMS-Rev. Macromol. Chem. Phys., C29, 201-317 (1989), which is incorporated by reference herein in its entirety.

“Mechanical Properties—Tensile, Hysteresis, and Tear”, stress-strain behavior in uniaxial tension is measured using ASTM D 1708 microtensile specimens. Samples are stretched with an Instron at 500% min⁻¹ at 21° C. Tensile strength and elongation at break are reported from an average of 5 specimens.

100% and 300% Hysteresis is determined from cyclic loading to 100% and 300% strains using ASTM D 1708 microtensile specimens with an Instron™ instrument. The sample is loaded and unloaded at 267% min⁻¹ for 3 cycles at 21° C. Cyclic experiments at 300% and 80° C. are conducted using an environmental chamber. In the 80° C. experiment, the sample is allowed to equilibrate for 45 minutes at the test temperature before testing. In the 21° C., 300% strain cyclic experiment, the retractive stress at 150% strain from the first unloading cycle is recorded. Percent recovery for all experiments are calculated from the first unloading cycle using the strain at which the load returned to the base line. The percent recovery is defined as:

$$\% Recovery = \frac{{ɛ}_{f} - {ɛ}_{s}}{{ɛ}_{f}} \times 100$$

where ε_{f} is the strain taken for cyclic loading and εₛ is the strain where the load returns to the baseline during the 1^{st} unloading cycle.

“Block Index” of the ethylene/α-olefin interpolymers is characterized by an average block index (ABI) which is greater than zero and up to about 1.0 and a molecular weight distribution, M_{w}/Mₙ, greater than about 1.3. The ABI is the weight average of the block index (BI) for each of the polymer fractions obtained in preparative TREF (fractionation of a polymer by Temperature Rising Elution Fractionation) from 20° C. and 110° C., with an increment of 5° C. (although other temperature increments, such as 1° C., 2° C., 10° C., also can be used):

ABI=Σ(wᵢBIᵢ)

where BIᵢ is the block index for the ith fraction of the inventive ethylene/α-olefin interpolymer obtained in preparative TREF, and wᵢ is the weight percentage of the ith fraction. Similarly, the square root of the second moment about the mean, hereinafter referred to as the second moment weight average block index, can be defined as follows.

$${2}^{nd} moment weight average BI = \sqrt{\frac{\sum ( {{w}_{i} ( {BI}_{i} - ABI )}^{2} )}{\frac{( N - 1 ) \sum {w}_{i}}{N}}}$$

where N is defined as the number of fractions with BIᵢ greater than zero. BI is defined by one of the two following equations (both of which give the same BI value):

$$BI = \frac{1 / {T}_{X} - 1 / {T}_{XO}}{1 / {T}_{A} - 1 / {T}_{AB}} or BI = - \frac{{LnP}_{X} - {LnP}_{XO}}{{LnP}_{A} - {LnP}_{AB}}$$

where T_{X} is the ATREF (analytical TREF) elution temperature for the ith fraction (preferably expressed in Kelvin), P_{X} is the ethylene mole fraction for the ith fraction, which can be measured by NMR or IR as described below. P_{AB} is the ethylene mole fraction of the whole ethylene/α-olefin interpolymer (before fractionation), which also can be measured by NMR or IR. T_{A} and P_{A} are the ATREF elution temperature and the ethylene mole fraction for pure “hard segments” (which refer to the crystalline segments of the interpolymer). As an approximation or for polymers where the “hard segment” composition is unknown, the T_{A} and P_{A} values are set to those for high density polyethylene homopolymer.

T_{AB} is the ATREF elution temperature for a random copolymer of the same composition (having an ethylene mole fraction of P_{AH}) and molecular weight as the inventive copolymer. T_{AB} can be calculated from the mole fraction of ethylene (measured by NMR) using the following equation:

LnP_{AB}=α/T_{AB}+β

where α and β are two constants which can be determined by a calibration using a number of well characterized preparative TREF fractions of a broad composition random copolymer and/or well characterized random ethylene copolymers with narrow composition. It should be noted that α and β may vary from instrument to instrument. Moreover, one would need to create an appropriate calibration curve with the polymer composition of interest, using appropriate molecular weight ranges and comonomer type for the preparative TREF fractions and/or random copolymers used to create the calibration. There is a slight molecular weight effect. If the calibration curve is obtained from similar molecular weight ranges, such effect would be essentially negligible. Random ethylene copolymers and/or preparative TREF fractions of random copolymers satisfy the following relationship:

LnP=−237.83/T_{ATRFF}+0.639

The above calibration equation relates the mole fraction of ethylene, P, to the analytical TREF elution temperature, T_{ATREF}, for narrow composition random copolymers and/or preparative TREF fractions of broad composition random copolymers. T_{XO} is the ATREF temperature for a random copolymer of the same composition (i.e., the same comonomer type and content) and the same molecular weight and having an ethylene mole fraction of P_{X}. T_{XO} can be calculated from LnPX=α/T_{XO}+β from a measured P_{X} mole fraction. Conversely, P_{XO} is the ethylene mole fraction for a random copolymer of the same composition (i.e., the same comonomer type and content) and the same molecular weight and having an ATREF temperature of T_{X}, which can be calculated from Ln P_{XO}=a/T_{X}+β using a measured value of T_{X}. Once the block index (BI) for each preparative TREF fraction is obtained, the weight average block index, ABI, for the whole polymer can be calculated. Determination of Block Index is also described in US Patent Application Publication No. 2006-019930, which is herein incorporated by reference.

The olefin block copolymers of the present invention preferably have a density from 0.85 to 0.895 g/cc, more preferably from 0.86 to 0.89 g/cc, and even more preferably from 0.87 to 0.88 g/cc.

The olefin block copolymers of the present invention preferably have a Shore A hardness from 15 to 95, more preferably from 40 to 90, and even more preferably from 70 to 90.

The olefin block copolymers of the present invention preferably have an I₁₀/I₂ from 5 to 35, more preferably from 5.5 to 25, even more preferably from 6 to 10.

The olefin block copolymers of the present invention have an Mw/Mn from greater than about 1.3, preferably from 1.9 to 7, more preferably from 2 to 5, even more preferably from 2 to 3.

The olefin block copolymers of the present invention preferably have a mol percent comonomer from 8 to 40, more preferably from 9 to 30, even more preferably from 10 to 20.

The olefin block copolymers of the present invention preferably have a soft segment content by weight percent from 40 to 95, more preferably from 50 to 95, even more preferably from 60 to 90.

The olefin block copolymers of the present invention have a block index (weight averaged) greater than zero and up to about 1.0, preferably from 0.15 to 0.8, more preferably from 0.2 to 0.7, even more preferably from 0.4 to 0.6.

The graft-modified propylene polymer (d)(i) and/or alpha-olefin-carboxylic acid copolymer (d)(ii) and/or olefin block copolymer (d)(iii) is employed in the carbonate polymer blend compositions of the present invention in amounts sufficient to provide the desired balance of physical properties, impact resistance, processability, and reduced gloss in molded articles. The graft-modified propylene polymer and/or alpha-olefin-carboxylic acid copolymer and/or olefin block copolymer can be employed independently in amounts of equal to or greater than about 0.1 part by weight, preferably equal to or greater than about 0.5 part by weight, preferably equal to or greater than about 1 part by weight, preferably equal to or greater than about 2 part by weight, preferably equal to or greater than about 4 part by weight, and most preferably equal to or greater than about 5 part by weight based on the total weight of the carbonate polymer blend composition. In general, the graft-modified propylene polymer and/or alpha-olefin-carboxylic acid copolymer and/or olefin block copolymer is used independently in amounts less than or equal to about 30 parts by weight, preferably less than or equal to about 20 parts by weight, preferably less than or equal to about 18 parts by weight, preferably less than or equal to about 16 parts by weight, and most preferably less than or equal to about 10 parts by weight based on the total weight of the carbonate polymer blend composition.

Optionally, the carbonate polymer blend composition comprises component (e) a filler such as calcium carbonate, talc, clay, mica, wollastonite, hollow glass beads, titaninum oxide, silica, carbon black, glass fiber or potassium titanate. Preferred fillers are talc, wollastonite, clay, single layers of a cation exchanging layered silicate material or mixtures thereof. Talcs, wollastonites, and clays are generally known tillers for various polymeric resins. See for example U.S. Pat. Nos. 5,091,461 and 3,424,703; EP 639,613 A1; and EP 391,413, where these materials and their suitability as filler for polymeric resins are generally described. Examples of suitable commercially available mineral talcs are VANTALC F2003 available from Orlinger and JETFIL™700C available from Minerals Technology.

The carbonate polymer blend compositions included within the scope of this invention generally utilize such inorganic fillers (excluding the fibrous fillers such as glass fibers, carbons fibers, tertiary polymer fibers, etc.) with a number average particle size as measured by back scattered electron imaging using a scanning electron microscope of less than or equal to about 10 micrometers (μm) preferably less than or equal to about 3 μm, more preferably less than or equal to about 2 μm, more preferably less than or equal to about 1.5 μm and most preferably less than or equal to about 1.0 μm. In general, smaller average particle sizes equal to or greater than about 0.001 μm, preferably equal to or greater than about 0.01 μm, more preferably equal to or greater than about 0.1 μm, or most preferably equal to or greater than 0.5 μm, if available, could very suitably be employed.

Fillers may be employed to obtain optimized combinations of toughness and stiffness in the low gloss polymer compositions according to the present invention. If present, the filler is employed in an amount of equal to or greater than about 1 part by weight, preferably equal to or greater than about 3 parts by weight, more preferably equal to or greater than about 5 parts by weight, even more preferably equal to or greater than about 10 parts by weight, and most preferably equal to or greater than about 15 parts by weight based on the total weight of the carbonate polymer composition. Usually it has been found sufficient to employ an amount of filler less than or equal to about 50 parts by weight, preferably less than or equal to about 40 parts by weight, more preferably less than or equal to about 30 parts by weight, more preferably less than or equal to about 25 parts by weight, more preferably less than or equal to about 20 parts by weight, and most preferably less than or equal to about 15 parts by weight based the total weight of the carbonate polymer composition.

Further, the claimed carbonate polymer blend composition may also optionally contain (1) an additional polymer which is a thermoplastic resin other than components (a), (b), (c), or (d) described hereinabove. Preferred additional polymers are polyethylene, preferably low density polyethylene (LDPE), linear low density polyethylene (LLDPE), and high density polyethylene (HDPE), substantially linear ethylene polymers which are fully described in U.S. Pat. No. 5,272,236 and U.S. Pat. No. 5,278,272 and/or linear ethylene polymers which are fully disclosed in U.S. Pat. No. 3,645,992; U.S. Pat. No. 4,937,299; U.S. Pat. No. 4,701,432; U.S. Pat. No. 4,937,301; U.S. Pat. No. 4,935,397; U.S. Pat. No. 5,055,438; EP 129,368; EP 260,999; and WO 90/07526, polystyrene, polycyclohexylethane, polyesters, such as polyethylene terephthalate, ethylene/styrene interpolymers, syndiotactic PP, syndiotactic PS, ethylene/propylene copolymers (EP), ethylene/butane copolymers (EB), ethylene/propylene/diene terpolymer (EPDM), block copolymer impact modifiers, core shell impact modifiers, fully hydrogenated, partially hydrogenated, and non-hydrogenated styrene butadiene block and co-polymers, polyesters, polyamides, PEEK, PMMA, POM, PPO, ASA, Ionomers, AES, EMA, MBS, EVA, SMA, TPU, TPEs, sulfonated polyolefins, and mixtures thereof. If present, the additional polymer is employed in amounts of equal to or greater than about 1 part by weight, preferably equal to or greater than about 3 parts by weight, more preferably equal to or greater than about 5 parts by weight, and most preferably equal to or greater than about 7 parts by weight based on the weight of the carbonate polymer blend composition. In general, the additional polymer is used in amounts less than or equal to about 40 parts by weight, preferably less than or equal to about 30 parts by weight, more preferably less than or equal to about 20 parts by weight, and most preferably 15 pails by weight based on the weight of the carbonate polymer blend composition.

Further, the claimed propylene polymer compositions may also optionally contain component (g) which is one or more additives that are commonly used in thermoplastic polymer compositions of this type. Preferred additives of this type include, but are not limited to: ignition resistant additives, stabilizers such as UV, thermal oxidation and process, colorants, chain extenders, chain repair additives, pigments, antioxidants, antistatic agents, flow enhancers, mold releases, such as metal stearates (e.g., calcium stearate, magnesium stearate), nucleating agents, including clarifying agents, etc. Preferred examples of additives are ignition resistance additives, such as, but not limited to halogenated hydrocarbons, halogenated carbonate oligomers, halogenated diglycidyl ethers, organophosphorous compounds, fluorinated olefins, antimony oxide and metal salts of aromatic sulfur, or a mixture thereof may be used. Further, compounds which stabilize polymer compositions against degradation caused by, but not limited to heat, light, and oxygen, or a mixture thereof may be used.

If used, such additives may be present in an amount from equal to or greater than about 0.01 parts, preferably equal to or greater than about 0.1 parts, more preferably equal to or greater than about 1 parts, more preferably equal to or greater than about 2 parts and most preferably equal to or greater than about 5 parts by weight based on the total weight of the carbonate polymer blend composition. Generally, the additive is present in an amount less than or equal to about 25 parts, preferably less than or equal to about 20 parts, more preferably less than or equal to about 15 parts, more preferably less than or equal to about 12 parts, and most preferably less than or equal to about 10 parts by weight based on the total weight of the carbonate polymer blend composition.

Preparation of the carbonate polymer blend compositions of this invention can be accomplished by any suitable mixing means known in the art. For example, all the ingredients may be placed into an extrusion compounder (extruder) and melt blended, extruded and chopped to produce molding pellets. Alternatively, the ingredients may be mixed by dry blending the individual components, then either fluxed on a mill and comminuted, or extruded and chopped. Alternatively, the ingredients may be dry mixed or metered into and directly molded, e.g., by injection or transferred molding techniques.

In another embodiment, the carbonate polymer blend compositions may be prepared by first forming a concentrate or masterbatch of any one or more of the ingredients in the polycarbonate and/or polypropylene resin or any compatible additional polymer (i.e., one which will not cause delamination and/or other detrimental effects in the final carbonate polymer blend composition). The concentrate or masterbatch may be extruded and cut up into molding compounds such as conventional granules, pellets, and the like by standard techniques. Thereafter the concentrate or masterbatch may be incorporated (sometimes referred to as let down) with other ingredients by any of the foregoing methods or other blending methods known in the art.

The carbonate polymer blend compositions of the present invention are thermoplastic. When softened or melted by the application of heat, the polymer blend compositions of this invention can be formed or molded using conventional techniques such as compression molding, injection molding, gas assisted injection molding, calendering, vacuum forming, thermoforming, extrusion and/or blow molding, alone or in combination. The carbonate polymer blend compositions can also be formed, spun, or drawn into films, fibers, multi-layer laminates or extruded sheets, or can be compounded with one or more organic or inorganic substances, on any machine suitable for such purpose. The carbonate polymer blend compositions of the present invention are preferably injection molded or extruded into articles. Some of the fabricated articles include exterior and interior automotive parts, for example, bumper beams, bumper fascia, pillars, automotive interior trim, automotive interior overhead consoles, automotive interior bezels, knee bolsters, steering column cowls, glove box trim, instrument panels and the like; in electrical and electrical equipment device housing and covers; as well as other household and personal articles, including, for example, appliance housings, house wares, freezer containers, and crates; lawn and garden furniture; lawn and garden power-equipment housings, and building and construction sheet.

To illustrate the practice of this invention, examples of the preferred embodiments are set forth below. However, these examples do not in any manner restrict the scope of this invention.

### EXAMPLES

To illustrate the practice of this invention, examples of preferred embodiments are set forth below. However, these examples do not in any manner restrict the scope of this invention.

Examples 1 to 24 and Comparative Examples A to H are prepared as follows: A carbonate polymer, a propylene polymer, a compatibilizing graft copolymer and optionally a graft modified propylene and/or an olefin-carboxylic acid copolymer are dry blended together. The carbonate polymer is dried for at least 5 hours at 90° C. prior to compounding. The dry blend is tumbled for 15 minutes then extruded through a Werner and Pfleiderer ZSK 25-3 twin screw extruder at a feed rate of 15 kg per hour, a screw speed of 250 revolutions per minute, a torque of 40-45 percent and a target temperature profile of 180/225/260/270/280/285/290° C. (from feed inlet to die). The extrudate is comminuted in a strand chopper as pellets.

The pellets are used to prepare A5 plaque physical property test specimens (other than gloss test specimens) on a Arburg 470 ton injection molding machine. The pellets are dried for at least four hours at 100° C. prior to injection molding. The following are the injection molding conditions: Barrel temperature: 265/280/280/275/255/55° C. from die to hopper; Mold temperature of 70° C.; Injection speed: 35 mm/s; Holding pressure of 500 bar/1 s; 450 bar/3 s; 400 bar/3 s; 350 bar/3 s; Back pressure: 5 bar; and Cooling time of 32 seconds.

The pellets are used to prepare 60 degree grain gloss test specimens on a Demag Ergotech 100 injection molding machine. Plaques are molded under two different conditions referred to as “Grain Glossₜₒₚ” and “Grain Gloss_{bottom}”. The two conditions differ only in injection speed. Grain Glossₜₒₚ condition has an injection speed of 60 mm/sec resulting in a fill time of about 0.51 sec and an overall cycle time of 38 sec. Grain Gloss_{bottom} condition has an injection speed of 5 mm/sec with a fill time of about 5.5 sec and an overall cycle time of about 43 sec. The following molding conditions are the same for both Grain Glossₜₒₚ conditions and Grain Gloss_{bottom} conditions: Barrel temperature settings from the hopper of 50, 265, 270, 275, and 280° C.; Nozzle temperature of 280° C., Mold temperature (both sides) of 70° C.; Back pressure: 75 bar; Holding pressure 600 bar; Holding time 4 seconds; Cavity switch point: 10 mm; Screw back: 36 mm; Dosing stroke: 33 mm; and Dosing speed: 100 U/min.

Before molding, the materials are dried for two hours at 80° C. Gloss is measured in the center of the plaque. The materials are injected through one injected point located in the middle of the short side of the mold. The mold surface is produced by a textured mold insert called Flat Sandblast 3 with a surface roughness of about 7.8 micrometers. “Delta Grain Gloss” is the absolute value of the difference between Grain Glossₜₒₚ minus Grain Gloss_{bottom}:

Delta Grain Gloss=|Grain Glossₜₒₚ−Grain Gloss_{bottom}|

Preferably, the carbonate polymer blend compositions of the present invention are a low gloss carbonate polymer blend composition having a Grain Glossₗₒₚ of equal to or less than about 10, more preferably equal to or less than about 8.5, more preferably equal to or less than about 8, more preferably equal to or less than about 7.5, and most preferably equal to or less than about 7. Preferably, the carbonate polymer blend compositions of the present invention are a low gloss carbonate polymer blend composition having a Delta Grain Gloss of equal to or less than about 7, more preferably equal to or less than about 4.5, more preferably equal to or less than about 2, more preferably equal to or less than about 1, and most preferably equal to or less than about 0.5.

The formulation content of Examples 1 to 24 and Comparative Examples A to H are given in Table 1 below. Amounts are given in parts by weight based on the total weight of the combined components (a) (carbonate polymer), (b) (a propylene polymer), (c) a compatibilizing graft copolymer and optionally (d)(i) a graft modified propylene and/or (d)(ii) an olefin-carboxylic acid copolymer. In Tables 1 and 3:

“PC-1” is a linear bisphenol-A polycarbonate with a melt flow rate of 10 g/10 min at 300° C. and an applied load of 1.2 kg available as CALIBRE™300-10 Polycarbonate Resin from The Dow Chemical Company;

“PC-2” is a linear bisphenol-A polycarbonate with a melt flow rate of 23 g/10 min at 300° C. and an applied load of 1.2 kg;

“PP-1” is an impact propylene random copolymer with an ethylene content of about 3 weight percent, having a density of about 0.9 g/cm³, a MFR of about 7 g/10 min available as Dow Polypropylene C 767-07 from The Dow Chemical Company;

“PP-2” is propylene polymer composition comprising about 75 weight percent of an impact propylene copolymer with an ethylene content of about 15 weight percent, having a density of about 0.9 g/cm³, a MFR of about 12 g/10 min, about 5 weight percent of a saturated substantially linear ethylene-octene copolymer comprising about 20 weight percent 1-octene having a density of 0.868 g/cm³, a molecular weight of about 160,000, and a MFR of 0.5 g/10 min at 190° C. under a load of 2.16 kg, about 5 weight percent of a linear low density polyethylene polymer, and about 15 weight percent of a high-purity, asbestos-free hydrous magnesium silicate talc;

“EPDM-g-SAN” an non cross-linked EPDM grafted with about 50 weight percent SAN where greater than 90 percent of the SAN is grafted onto the EPDM and is available as ROYALTUF™372P20 from Chemtura;

“PP-g-PMMA” is a PP homopolymer grafted with about 11 weight percent methyl methacrylate with a MFR of 6.3 g/10 min at 190° C. under a load of 2.16 kg in the form of a powder and available as SCONA™ TPPP 2507 FA from Kometra GMBH;

“PP-g-PAA” is an acrylic acid modified homopolymer polypropylene with about 6 weight percent acrylic acid having a MFR of 40 g/10 min at 230° C. under a load of 2.16 kg in the form of pellets and available as POLYBOND™1001 from Crompton Corporation; and

“EAA” is an ethylene acrylic acid copolymer comprising about 10 weight percent acrylic acid with a density of 0.938 g/cm³ and a MFR of 1.5 g/10 min at 190° C. under a load of 2.16 kg available as PRIMACOR™1410 EAA Copolymer from The Dow Chemical Company.

TABLE 1

| | Comparative | | | | | EPDM- | | PP-g- | PP-g- |
|---|---|---|---|---|---|---|---|---|---|
| Example | Example | PC-1 | PC-2 | PP-1 | PP-2 | g-SAN | EAA | PMMA | PAA |
| | A | 62 | | | 20 | 18 | | | |
| | B | 62 | | | 34 | 4 | | | |
| | C | 62 | | | 22 | 16 | | | |
| | D | 62 | | 22 | | 16 | | | |
| | E | 62 | | | | 8 | 30 | | |
| | F | 62 | | | | 8 | | 30 | |
| | G | 62 | | | | 16 | 22 | | |
| | H | 62 | | | | 16 | | 22 | |
| 1 | | 62 | | | 20 | 5 | 13 | | |
| 2 | | 62 | | | 20 | 9 | 9 | | |
| 3 | | 62 | | | 20 | 15 | 3 | | |
| 4 | | 62 | | | 26 | 9 | 3 | | |
| 5 | | 62 | | | 34 | 1 | 3 | | |
| 6 | | 62 | | 20 | | 15 | 3 | | |
| 7 | | 62 | | 22 | | 13 | 3 | | |
| 8 | | 62 | | | 22 | 13 | | 3 | |
| 9 | | 62 | | | 26 | 9 | | 3 | |
| 10 | | 62 | | | 34 | 1 | | 3 | |
| 11 | | 62 | | 22 | | 15 | | 1 | |
| 12 | | 62 | | 22 | | 13 | | 3 | |
| 13 | | 62 | | 22 | | 8 | | 8 | |
| 14 | | 62 | | | 17 | 15 | 3 | 3 | |
| 15 | | | | 17 | | 15 | 3 | 3 | |
| 16 | | 62 | | 22 | | 13 | 2.5 | 0.5 | |
| 17 | | 62 | | 22 | | 13 | 1.5 | 1.5 | |
| 18 | | 62 | | 22 | | 13 | 0.5 | 2.5 | |
| 19 | | 62 | | | 17 | 15 | | 3 | 3 |
| 20 | | 62 | | 17 | | 15 | | 3 | 3 |
| 21 | | 62 | | 8.5 | 8.5 | 15 | | 3 | 3 |
| 22 | | 62 | | 8.5 | 8.5 | 15 | 3 | 3 | |
| 23 | | | 62 | | 17 | 15 | 3 | 3 | |
| 24 | | | 62 | 17 | | 15 | 3 | 3 | |

The following tests are run on Examples 1 to 24 and Comparative Examples A to H and the results of these tests are shown in Tables 2 and 4:

“Grain Gloss_{bottom}” is determined by 60° Gardner gloss on specimens prepared from Gloss_{bottom} conditions (described hereinabove) molded on a textured plaque with a grain surface of about 7.8 microns and measuring about 8 cm×10 cm×3 mm, 30 minutes after molding, according to ISO 2813 with “Dr. Lange R63” reflectometer;

“Grain Glossₜₒₚ” is determined by 60° Gardner gloss on specimens prepared from Glossₜₒₚ conditions (described hereinabove) molded on a textured plaque with a grain surface of about 7.8 microns and measuring about 8 cm×10 cm×3 mm, 30 minutes after molding, according to ISO 2813 with “Dr. Lange RB3” reflectometer;

“G′” is storage modulus as determined on a Rheometrics ARES rheometer (Orchestrator software version 6.5.6), running a temperature ramp on parallel plate fixtures. Samples were compression molded at 200° C. The temperature was ramped from 135 to 250° C. at a rate of 3 degrees per minute and measurements were taken using a shear rate of 1.0 radian/second. The G′ was recorded at 120 degrees C. above the matrix Tg. The matrix Tg was defined via a solid state temperature ramp, run in torsion, on the DMS. The tan delta peak value was recorded as the transition temperature. The temperature ramp defining Tg was run from 20° C. to about 150° C. at a ramp rate of 3 degrees per minute and at a shear rate of 1.0 radian/second;

“Tensile Yield”, “Tensile Break Elongation” and “Tensile Modulus” are performed in accordance with ISO 527. Tensile Type 1 test specimens are conditioned at 23° C. and 50 percent relative humidity 24 hours prior to testing. Testing is performed at 23° C. using a Zwick 1455 mechanical tester;

“Notched Izod” is notched Izod impact resistance determined according to ISO 180 at 23° C. and −30° C. in a standard Izod impact testing unit equipped with a cold temperature chamber;

“Notched Charpy” is notched Charpy impact resistance determined according to DIN 53453 at 23° C. and −30° C. in a standard Charpy impact testing unit equipped with a cold temperature chamber;

“MFR” melt flow rate is determined according to ISO 1133 on a Zwick 4105 01/03 plastometer at 230° C. and an applied load of 3.8 kg or 260° C. and an applied load of 5 kg samples are conditioned at 80° C. for 2 hours before testing;

“HDT” heat distortion temperature is determined at 0.45 MPa or 1.82 MPa in accordance with ISO 175B; and

“Vicat” softening temperature is determined at 120° C. and an applied load of 1 kg in accordance with ISO 179.

Examples 25 to 32 are prepared by the same method described hereinabove for Examples 1 to 24 and Comparative Examples A to H.

The resulting pellets are used to prepare 60 degree grain gloss test specimens and physical property test specimens on a Demag 150/PTC3 injection molding machine. The pellets are dried for at least four hours at 100° C. prior to injection molding. The following are the injection molding conditions: Barrel temperature: 280/280/275/270/265/50° C. from die to hopper; Mold temperature of 70° C.; Injection speed: 5 s to 5.5 s; Holding pressure of 600 bar; Back pressure of 75 bar; and Cooling time of 25 seconds.

The formulation content of Examples 25 to 32 are given in Table 3 below. Amounts are given in parts by weight based on the total weight of the combined components (a) (carbonate polymer), (b) (a propylene polymer), (c) a compatibilizing graft copolymer, (d)(i) a graft modified propylene, and (d)(iii) an olefin block copolymer. In Table 3:

“PP-3” is a propylene copolymer comprising about 8 percent weight percent ethylene having a density of 0.9 g/cm³ and a MFR of 12 g/10 min at 230° C. under a load of 2.16 kg available as INSPIRE™ C715-12N HP from The Dow Chemical Company;

“OBC-1” is an ethylene-octene block copolymer having an I₂ melt index (190° C./2.14 kg) of 1 g/10 min, a density of 0.877 glee, a percent hard segment of 27, and a Shore A hardness of 75;

“OBC-2” is an ethylene-octene block copolymer having an I₂ melt index (190° C./2.14 kg) of 5 g/10 min, a density of 0.866 g/ee, a percent hard segment of 12, and a Shore A hardness of 59;

“OBC-3” is an ethylene-octene block copolymer having an I₂ melt index (190° C./2.14 kg) of 5 g/10 min, a density of 0.887 glee, a percent hard segment of 49, and a Shore A hardness of 86;

OBC-4″ is an ethylene-propylene block copolymer having an 12 melt index (190° C./2.14 kg) of 5.2 g/10 min, a density of 0.8573 g/cc, and a Shore A hardness of 40; and

OBC-5″ is an ethylene-propylene block copolymer having an I₂ melt index (190° C./2.14 kg) of 4.37 g/10 min, a density of 0.8747 glee, and a Shore A hardness of 66.

| | | Grain Gloss | | G′ | | Tensile | | | Notched Izod | |
|---|---|---|---|---|---|---|---|---|---|---|
| | Comparative | top | bottom | @50° C. | @ 130° C. | Yield | Elongation | Modulus | @ 23° C. | @ −30° C. |
| Example | Example | (%) | (%) | (10⁸ Pa) | (10⁸ Pa) | (MPa) | (%) | (MPa) | (kJ/m²) | (kJ/m²) |
| | A | 7.6 | 9.2 | 4.7 | 2.2 | 38.7 | 31.3 | 1960 | 53.7 | 12.7 |
| | B | 6.9 | 9.9 | 8.1 | 4.8 | 38.2 | 3.9 | 2360 | 5.1 | 4.5 |
| | C | 6.6 | 12 | | | 37.0 | 37.3 | 1900 | 37.6 | 13.1 |
| | D | 6.1 | 10.3 | | | 38.5 | 16 | 1650 | 68.1 | 25.7 |
| | E | 7.6 | 9.2 | | | 34.2 | 6.1 | 1310 | | |
| | F | 7.4 | 9.9 | | | 35.9 | 6 | 1680 | | |
| | G | 7.4 | 9.3 | | | 34.9 | 5.8 | 1400 | | |
| | H | 7.0 | 9.8 | | | 35.9 | 5 | 1700 | | |
| 1 | | 6.7 | 6.5 | 3.7 | 2.0 | 34.6 | 8.5 | 1600 | 10.7 | 5.4 |
| 2 | | 6.6 | 6.8 | 3.9 | 2.3 | 34.1 | 9.6 | 1540 | 11.6 | 5.8 |
| 3 | | 7.7 | 8.4 | 4.0 | 2.2 | 35.7 | 13 | 1640 | 26.0 | 10.2 |
| 4 | | 7.2 | 7.5 | 4.5 | 2.6 | 36.0 | 9.6 | 1690 | 14.0 | 7.4 |
| 5 | | 6.4 | 6.3 | 5.0 | 2.9 | 34.5 | 6.1 | 1740 | 7.1 | 4.8 |
| 6 | | 5.3 | 9.3 | | | 37.5 | 16 | 1610 | 76.2 | 19.5 |
| 7 | | | | | | 36.6 | 5.4 | 1560 | | |
| 8 | | 6.6 | 12.9 | | | 39.5 | 33 | 1980 | 60.8 | 9.1 |
| 9 | | 7.2 | 9.3 | 6.8 | 3.4 | 39.1 | 5.6 | 2140 | 7.3 | 6.5 |
| 10 | | 7.2 | 9.2 | 7.8 | 4.4 | 39.5 | 4.9 | 2330 | 15.4 | 7.7 |
| 11 | | | | | | 37.5 | 5.1 | 1650 | | |
| 12 | | 5.8 | 9.7 | | | 39.2 | 11 | 1670 | 76.9 | 28.0 |
| 13 | | | | | | 38.2 | 4.7 | 1710 | | |
| 14 | | 6.6 | 10.5 | | | 36.8 | 15 | 1620 | 66.7 | 11.4 |
| 15 | | 7.3 | 11.0 | | | 37.9 | 11 | 1540 | 76.9 | 14.9 |
| 16 | | | | | | 36.8 | 5.5 | 1570 | | |
| 17 | | | | | | 37.1 | 5.3 | 1610 | | |
| 18 | | | | | | 37.4 | 5.2 | 1610 | | |
| 19 | | 6.6 | 10.5 | | | 36.6 | 6 | 1830 | 69 | |
| 20 | | 7.3 | 11.0 | | | 35 | 6 | 1680 | 56.7 | |
| 21 | | 8.3 | 11.9 | | | 35.2 | 6 | 1760 | 59 | |
| 22 | | 6.5 | 10.9 | | | 37.2 | 11 | 1610 | 72.9 | 11.7 |
| 23 | | | | | | 36.6 | 62.6 | 1600 | 37.7 | 10 |
| 24 | | | | | | 38.3 | 30.2 | 1600 | 54.8 | 10.7 |

| | | | | MFR | | | | Vicat |
|---|---|---|---|---|---|---|---|---|
| | | Notched Charpy | | @ 230° C./ | @ 260° C./ | HDT | | @ 120° C./ |
| | Comparative | @ 23° C. | @ −30° C. | 3.8 kg | 5 kg | @ 0.45 MPa | @ 1.82 MPa | 1 kg |
| Example | Example | (kJ/m²) | (kJ/m²) | (g/10 min) | (g/10 min) | (° C.) | (° C.) | (° C.) |
| | A | | | | | 128.9 | | 143.3 |
| | B | | | | | 125.3 | | 140.1 |
| | C | | | 4.6 | | 128.3 | | 146.1 |
| | D | | | 3.0 | | 130 | | 149.7 |
| | E | 101.2 | 65.8 | | 11.6 | | 99.7 | 131.3 |
| | F | 14.8 | 7 | | 38.6 | | 101.3 | 147.3 |
| | G | | 23.8 | | | | 102.6 | 146.2 |
| | H | 25.2 | 7.2 | | 31.9 | | 100.8 | 146.6 |
| 1 | | | | | | 126.0 | | 143.7 |
| 2 | | | | | | 127.3 | | 143.5 |
| 3 | | | | | | 126.6 | | 142.5 |
| 4 | | | | | | 128.4 | | 144.7 |
| 5 | | | | | | 128.4 | | 148.5 |
| 6 | | | | 2.0 | | 130.1 | | 149.1 |
| 7 | | 80.5 | 10.6 | | 9.9 | | 99.2 | 147.9 |
| 8 | | | | 5.0 | | 131.2 | | 147.1 |
| 9 | | | | | | 128.2 | | 144.5 |
| 10 | | | | | | 130.9 | | 147.6 |
| 11 | | | 19.6 | | 22.4 | | 101.8 | 148.7 |
| 12 | | | | 3.4 | | 130.6 | | 149 |
| 13 | | 66.9 | 9.4 | | 59 | | 100.9 | 148.7 |
| 14 | | | | 1.6 | | | 102.8 | 128.7 |
| 15 | | | | 2.2 | | 129.7 | | 149.1 |
| 16 | | 85 | 10.6 | | 11.2 | | 103.5 | 148.5 |
| 17 | | 88 | 12.2 | | 14.8 | | 104.4 | 150.4 |
| 18 | | 66.4 | 8.4 | | 20.6 | | 103.7 | 149.8 |
| 19 | | | | 2.7 | | 106.8 | | 147.3 |
| 20 | | | | 2.8 | | 105.5 | | 147.2 |
| 21 | | | | 2.9 | | 106.2 | | 147.8 |
| 22 | | | | 1.5 | | 129.4 | | 148.8 |
| 23 | | | | 3.8 | | | 106.8 | 128 |
| 24 | | | | 3.9 | | | 105.5 | 129 |

TABLE 3

| | | | EPDM- | PP-g- | | | | | |
|---|---|---|---|---|---|---|---|---|---|
| Example | PC-1 | PP-3 | g-SAN | PMMA | OBC-1 | OBC-2 | OBC-3 | OBC-4 | OBC-5 |
| 25 | 62 | 10 | 15 | 3 | 10 | | | | |
| 26 | 62 | 10 | 15 | 3 | | 10 | | | |
| 27 | 62 | 10 | 15 | 3 | | | 10 | | |
| 28 | 62 | 15 | 15 | 3 | 5 | | | | |
| 29 | 62 | 15 | 15 | 3 | | 5 | | | |
| 30 | 62 | 15 | 15 | 3 | | | 5 | | |
| 31 | 62 | 15 | 15 | 3 | | | | 5 | |
| 32 | 62 | 15 | 15 | 3 | | | | | 5 |

The following tests are run on Examples 25 to 32 and the results of these tests are shown in Table 4. In Table 4:

“Flexural Modulus” is performed in accordance with ISO 178; and

“Instrumented Dart Impact” is determined according to ASTM 3763 at −10° C. and 23° C.

TABLE 4

| | | | | Tensile | | Instrumented | | | | MFR | HDT | Vicat |
|---|---|---|---|---|---|---|---|---|---|---|---|---|
| | Grain Gloss | | Flexural | Elonga- | | Dart Impact | | Notched Charpy | | @ 260° C./ | @ 0.45 | @ 120° C./ |
| Ex- | top | bottom | Modulus | tion | Modulus | @ 23° C. | @ −10° C. | @ 23° C. | @ −30° C. | 5 kg | MPa | 1 kg |
| ample | (%) | (%) | (MPa) | (%) | (MPa) | (J) | (J) | (kJ/m²) | (kJ/m²) | (g/10 min) | (° C.) | (° C.) |
| 25 | 9.51 | 12.68 | 1441 | 38.2 | 1357 | 29.8 | 6.8 | 75.3 | 18.3 | 16.4 | 105.0 | 148.7 |
| 26 | 8.48 | 11.66 | 1491 | 18.9 | 1388 | 32.5 | 16.7 | 102.9 | 19.9 | 18.1 | 108.9 | 147.3 |
| 27 | 9.05 | 12.24 | 1541 | 23.3 | 1391 | 26.7 | 5.6 | 85.9 | 17.0 | 17.5 | 106.9 | 148.0 |
| 28 | 8.33 | 9.76 | 1577 | 24.9 | 1430 | 11.7 | 4.4 | 45.1 | 15.1 | 20.0 | 106.0 | 148.6 |
| 29 | 9.25 | 11.93 | 1589 | 38.2 | 1424 | 17.8 | 4.9 | 71.6 | 15.5 | 20.9 | 107.1 | 148.4 |
| 30 | 8.19 | 11.29 | 1601 | 23.1 | 1425 | 15.4 | 4.5 | 57.6 | 13.7 | 20.6 | 106.4 | 147.9 |
| 31 | 9.3 | 11.92 | 1490 | 20.1 | 1348 | 16.5 | 4.4 | 43.3 | 13.4 | 20.42 | 104.4 | 148.1 |
| 32 | 7.58 | 9.63 | 1533 | 35.0 | 1395 | 16.3 | 4.1 | 41.0 | 12.7 | 21.1 | 107.0 | 148.4 |

1. A carbonate polymer blend composition comprising:
(a) a carbonate polymer in an amount from about 10 to about 90 parts by weight;
(b) a propylene polymer in an amount from about 10 to about 90 parts by weight;
(c) a compatibilizing graft copolymer in an amount from about 2 to about 30 parts by weight;
(d) a polymer in an amount from about 0.1 to about 25 parts by weight selected from
(i) a graft modified propylene polymer and/or
(ii) an olefin-carboxylic acid copolymer; and/or
(iii) an olefin block copolymer comprising one or more hard segment and one or more soft segment having:
(iii.a) a weight average molecular weight/number average molecular weight ratio (Mw/Mn) from about 1.7 to about 3.5, at least one melting point (Tm) in degrees Celsius, and a density (d) in grams/cubic centimeter (g/cc), wherein the numerical values of Tm and d correspond to the relationship:
Tₘ>−2002.9+4538.5(d)−2422.2(d)² or Tₘ>−6553.3+13735(d)−7051.7(d)²; and/or
(iii.b) a Mw/Mn from about 1.7 to about 3.5, and is characterized by a heat of fusion (ΔH) in Jules per gram (J/g) and a delta quantity, ΔT, in degrees Celsius defined as the temperature difference between the tallest differential scanning calorimetry (DSC) peak and the tallest crystallization analysis fractionation (CRYSTAF) peak, wherein the numerical values of ΔT and ΔH have the following relationships:
ΔT>−0.1299(ΔH)+62.81 for ΔH greater than zero and up to 130 J/g,
ΔT≧48° C. for ΔH greater than 130 J/g,
wherein the CRYSTAF peak is determined using at least 5 percent of the cumulative polymer, and if less than 5 percent of the polymer has an identifiable CRYSTAF peak, then the CRYSTAF temperature is 30° C.; and/or
(iii.c) an elastic recovery (Re) in percent at 300 percent strain and 1 cycle measured with a compression-molded film of the ethylene/alpha-olefin interpolymer, and has a density (d) in grams/cubic centimeter (g/cc), wherein the numerical values of Re and d satisfy the following relationship when ethylene/alpha-olefin interpolymer is substantially free of a cross-linked phase:
Re>1481−1629(d); and/or
(iii.d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density, and molar comonomer content (based on the whole polymer) within 10 percent of that of the ethylene/alpha-olefin interpolymer; and/or
(iii.e) a storage modulus at 25° C. (G′(25° C.)) and a storage modulus at 100° C. (G′(100° C.)) wherein the ratio of G′(25° C.) to G′(100° C.) is in the range of about 1:1 to about 9:1 and/or
(iii.f) a molecular fraction which elutes between 40° C. and 130° C. when fractionated using TREF, characterized in that the fraction has a block index of at least 0.5 and up to about 1 and a molecular weight distribution, Mw/Mn, greater than about 1.3; and/or
(iii.g) an average block index greater than zero and up to about 1.0 and a molecular weight distribution, Mw/Mn, greater than about 1.3;
(e) optionally a filler;
(f) optionally a thermoplastic resin other than (a), (b), (c), or (d); and
(g) optionally one or more additive selected from stabilizers, pigments, mold release agents, flow enhancers, or antistatic agents,
wherein parts are based on the total weight of the carbonate polymer blend composition.

2. The carbonate polymer blend composition of claim 1 wherein the propylene polymer is a homopolymer of propylene.

3. The carbonate polymer blend composition of claim 1 wherein the compatibilizing graft copolymer is a vinylaromatic co-polymer grafted olefin elastomer or an acrylate graft modified propylene polymer.

4. The carbonate polymer blend composition of claim 1 wherein the compatibilizing graft copolymer is an EPDM-g-SAN polymer.

5. The carbonate polymer blend composition of claim 1 wherein the graft modified propylene polymer is a PP-g-PMMA polymer.

6. The carbonate polymer blend composition of claim 1 wherein the olefin-carboxylic acid copolymer is an EAA copolymer.

7. The carbonate polymer blend composition of claim 1 wherein the olefin block copolymer is a copolymer of ethylene with propylene, 1-butene, 1-hexene, or 1-octene.

8. The carbonate polymer blend composition of claim 1 wherein the olefin block copolymer has a density of from 0.85 to 0.895 g/cc and an I₂/I₁₀ of from 5 to 35.

9. The carbonate polymer blend composition of claim 1 wherein the olefin block copolymer has an average block index of from 0.15 to 0.8.

10. The carbonate polymer blend composition of claim 1 wherein the olefin block copolymer has a molecular weight distribution (Mw/Mn) of from 1.9 to 7.

11. The carbonate polymer blend composition of claim 1 wherein the olefin block copolymer has a soft segment content by weight percent of from 40 to 95.

12. The carbonate polymer blend composition of claim 1 wherein the filler is present in an amount from about 1 to about 50 parts by weight and is selected from talc, wollastonite, clay, single layers of a cation exchanging layered silicate material or mixtures thereof.

13. The carbonate polymer blend composition of claim 12 wherein the filler is talc.

14. The carbonate polymer blend composition of claim 1 wherein the additional polymer is present in an amount from about 1 to about 40 parts by weight and is selected from low density polyethylene, linear low density polyethylene, high density polyethylene, substantially linear ethylene polymer, linear ethylene polymer, polystyrene, polycyclohexylethane, polyester, ethylene/styrene interpolymer, syndiotactic polypropylene, syndiotactic polystyrene, ethylene/propylene copolymer, ethylene/propylene/diene terpolymer, ethylene/butane copolymers, block copolymer impact modifiers, core shell impact modifiers, fully hydrogenated, partially hydrogenated, and non-hydrogenated styrene butadiene block and co-polymers, polyesters, polyamides, PEEK, PMMA, POM, PPO, ASA, Ionomers, AES, EMA, MBS, EVA, SMA, TPU, TPEs, sulfonated polyolefins, or mixtures thereof.

15. The carbonate polymer blend composition of claim 1 having a Grain Glossₜₒₚ of less than 10 as determined by 60° Gardner gloss according to ISO 2813 from a plaque having a grain surface of about 7.8 microns.

16. The carbonate polymer blend composition of claim 1 having a Delta Grain Gloss of less than 7 as determined by 60° Gardner gloss according to ISO 2813 from a plaque having a grain surface of about 7.8 microns.

17. A method for preparing a carbonate polymer blend composition comprising the step of combining:
(a) a carbonate polymer in an amount from about 10 to about 90 parts by weight;
(b) a propylene polymer in an amount from about 10 to about 90 parts by weight;
(c) a compatibilizing graft copolymer in an amount from about 2 to about 30 parts by weight;
(d) a polymer in an amount from about 0.1 to about 25 parts by weight selected from
(i) a graft modified propylene polymer and/or
(ii) an olefin-carboxylic acid copolymer;
(iii) an olefin block copolymer comprising one or more hard segment and one or more soft segment having:
(iii.a) a weight average molecular weight/number average molecular weight ratio (Mw/Mn) from about 1.7 to about 3.5, at least one melting point (Tm) in degrees Celsius, and a density (d) in grams/cubic centimeter (g/cc), wherein the numerical values of Tm and d correspond to the relationship:
Tₘ>−2002.9+4538.5(d)−2422.2(d)² or Tₘ>−6553.3+13735(d)−7051.7(d)²; and/or
(iii.b) a Mw/Mn from about 1.7 to about 3.5, and is characterized by a heat of fusion (ΔH) in Jules per gram (J/g) and a delta quantity, ΔT, in degrees Celsius defined as the temperature difference between the tallest differential scanning calorimetry (DSC) peak and the tallest crystallization analysis fractionation (CRYSTAF) peak, wherein the numerical values of ΔT and ΔH have the following relationships:
ΔT>−0.1299(ΔH)+62.81 for ΔH greater than zero and up to 130 J/g,
ΔT>48° C. for ΔH greater than 130 J/g,
wherein the CRYSTAF peak is determined using at least 5 percent of the cumulative polymer, and if less than 5 percent of the polymer has an identifiable CRYSTAF peak, then the CRYSTAF temperature is 30° C.; and/or
(iii.c) an elastic recovery (Re) in percent at 300 percent strain and 1 cycle measured with a compression-molded film of the ethylene/alpha-olefin interpolymer, and has a density (d) in grams/cubic centimeter (g/cc), wherein the numerical values of Re and d satisfy the following relationship when ethylene/alpha-olefin interpolymer is substantially free of a cross-linked phase:
Re>1481−1629(d); and/or
(iii.d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density, and molar comonomer content (based on the whole polymer) within 10 percent of that of the ethylene/alpha-olefin interpolymer; and/or
(iii.e) a storage modulus at 25° C. (G′(25° C.)) and a storage modulus at 100° C. (G′(100° C.)) wherein the ratio of G′(25° C.) to G′(100° C.) is in the range of about 1:1 to about 9:1 and/or
(iii.f) a molecular fraction which elutes between 40° C. and 130° C. when fractionated using TREF, characterized in that the fraction has a block index of at least 0.5 and up to about 1 and a molecular weight distribution, Mw/Mn, greater than about 1.3; and/or
(iii.g) an average block index greater than zero and up to about 1.0 and a molecular weight distribution, Mw/Mn, greater than about 1.3;
(e) optionally a filler;
(f) optionally a thermoplastic resin other than (a), (b), (c), or (d); and
(g) optionally one or more additive selected from stabilizers, pigments, mold release agents, flow enhancers, or antistatic agents,
wherein parts are based on the total weight of the carbonate polymer blend composition.

18. A method for producing a molded or extruded article of a carbonate polymer blend composition comprising the steps of:
(A) preparing a carbonate polymer blend composition comprising:
(a) a carbonate polymer in an amount from about 10 to about 90 parts by weight;
(b) a propylene polymer in an amount from about 10 to about 90 parts by weight;
(c) a compatibilizing graft copolymer in an amount from about 2 to about 30 parts by weight;
(d) a polymer in an amount from about 0.1 to about 25 parts by weight selected from
(i) a graft modified propylene polymer and/or
(ii) an olefin-carboxylic acid copolymer;
(iii) an olefin block copolymer comprising one or more hard segment and one or more soft segment having:
(iii.a) a weight average molecular weight/number average molecular weight ratio (Mw/Mn) from about 1.7 to about 3.5, at least one melting point (Tm) in degrees Celsius, and a density (d) in grams/cubic centimeter (g/cc), wherein the numerical values of Tm and d correspond to the relationship:
Tₘ>−2002.9+4538.5(d)−2422.2(d)² or Tₘ>−6553.3+13735(d)−7051.7(d)²; and/or
(iii.b) a Mw/Mn from about 1.7 to about 3.5, and is characterized by a heat of fusion (ΔH) in Jules per gram (J/g) and a delta quantity, ΔT, in degrees Celsius defined as the temperature difference between the tallest differential scanning calorimetry (DSC) peak and the tallest crystallization analysis fractionation (CRYSTAF) peak, wherein the numerical values of ΔT and ΔH have the following relationships:
ΔT>−0.1299(ΔH)+62.81 for ΔH greater than zero and up to 130 J/g,
ΔT>48° C. for ΔH greater than 130 J/g,
wherein the CRYSTAF peak is determined using at least 5 percent of the cumulative polymer, and if less than 5 percent of the polymer has an identifiable CRYSTAF peak, then the CRYSTAF temperature is 30° C.; and/or
(iii.c) an elastic recovery (Re) in percent at 300 percent strain and 1 cycle measured with a compression-molded film of the ethylene/alpha-olefin interpolymer, and has a density (d) in grams/cubic centimeter (g/cc), wherein the numerical values of Re and d satisfy the following relationship when ethylene/alpha-olefin interpolymer is substantially free of a cross-linked phase:
Re>1481−1629(d); and/or
(iii.d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density, and molar comonomer content (based on the whole polymer) within 10 percent of that of the ethylene/alpha-olefin interpolymer; and/or
(iii.e) a storage modulus at 25° C. (G′(25° C.)) and a storage modulus at 100° C. (G′(100° C.)) wherein the ratio of G′(25° C.) to G′(100° C.) is in the range of about 1:1 to about 9:1 and/or
(iii.f) a molecular fraction which elutes between 40° C. and 130° C. when fractionated using TREF, characterized in that the fraction has a block index of at least 0.5 and up to about 1 and a molecular weight distribution, Mw/Mn, greater than about 1.3; and/or
(iii.g) an average block index greater than zero and up to about 1.0 and a molecular weight distribution, Mw/Mn, greater than about 1.3;
(e) optionally a filler;
(f) optionally a thermoplastic resin other than (a), (b), (c), or (d); and
(g) optionally one or more additive selected from stabilizers, pigments, mold release agents, flow enhancers, or antistatic agents,
wherein parts are based on the total weight of the carbonate polymer blend composition and
(B) molding or extruding said carbonate polymer blend composition into a molded or an extruded article.

19. The carbonate polymer blend composition of claim 1 in the form of a molded or an extruded article.

20. The molded or extruded article of claim 19 is selected from an automotive bumper beam, an automotive bumper fascia, an automotive pillar, an automotive instrument panel, an automotive interior trim, an automotive interior overhead console, an automotive interior bezel, a knee bolster, a steering column cowl, a glove box trim, an electrical equipment device housing, an electrical equipment device cover, an appliance housing, a freezer container, a crate, or lawn and garden furniture.
